(19) United States
(12) Patent Application Publication
(10) Pub. No.: US 2014/0240121 A1
(43) Pub. Date: Aug. 28, 2014

(54) WATCHING SYSTEM, INFORMATION PROCESSING APPARATUS, INFORMATION PROCESSING METHOD AND NON-TRANSITORY RECORDING MEDIUM RECORDED WITH PROGRAM

(71) Applicant: NK WORKS CO., LTD., Wakayama-shi (JP)

(72) Inventor: Toru Yasukawa, Wakayama-shi (JP)

(73) Assignee: NK WORKS CO., LTD., Wakayama-shi (JP)

(21) Appl. No.: 14/191,285

(22) Filed: Feb. 26, 2014

(30) Foreign Application Priority Data
Feb. 28, 2013 (JP) 2013-038574

(51) Int. Cl. G08B 1/08

(52) U.S. Cl. CPC G08B 1/08
USPC 340/539.11

(57) ABSTRACT

A watching system according to one aspect of the invention is disclosed, which includes a plurality of wireless communication tags attached to a watching target person with a behavior being watched, a receiving apparatus installed in a position as a reference for presuming the behavior of the watching target person and receiving information transmitted from the wireless communication tags, and an information processing apparatus specifying communication statuses of the wireless communication tags by determining whether the receiving apparatus can receive the information transmitted from the wireless communication tags and presuming the behavior of the watching target person attached with the wireless communication tags on the basis of the specified communication statuses of the wireless communication tags.

### FIELD

The present invention relates to a watching system, an information processing apparatus, an information processing method and a non-transitory recording medium recorded with a program.

### BACKGROUND

A technology (Japanese Patent Application Laid-Open Publication No. 2001-327549) exists, which detects a series of motion phases from a sleeping posture, a sitting-on-bed state with legs stretching long, a sitting-on-bed-edge state, a standing posture up to a walk starting state of a care receiver by use of a pressure-sensitive sheet and an optical sensor.

In recent years, there has been an annually increasing tendency of accidents that inpatients, care facility tenants, care receivers, etc fall down or come down from beds and of accidents caused by wandering of dementia patients. As a method of preventing such accidents, e.g., a hospital introduces a watching system for detecting behaviors of a watching target person such as a get-up state, a sitting-on-bed-edge state and a leaving-bed state by use of a load sensor, a body motion type wire, an infrared-ray sensor, etc. These methods, however, have problems of being easily affected by physical restraints such as reacting on a weight of an object other than the watching target person, entangling a body of the watching target person in the wire and intercepting the infrared-rays with an obstacle.

### SUMMARY

A watching system according to one aspect of the present invention includes: a plurality of wireless communication tags to be attached to a watching target person whose behavior is watched; a receiving apparatus to be installed in a position serving as a reference for presuming the behavior of the watching target person and to receive information transmitted respectively from the plurality of wireless communication tags; and an information processing apparatus to specify respective communication statuses of the plurality of wireless communication tags by determining whether or not the receiving apparatus can receive the information transmitted from the plurality of wireless communication tags and to presume the behavior of the watching target person attached with the plurality of wireless communication tags on the basis of the specified communication statuses of the plurality of wireless communication tags.

According to the configuration described above, the respective communication statuses of the plurality of wireless communication tags are specified by determining whether or not the receiving apparatus can receive the information transmitted from the plurality of wireless communication tags attached to the watching target person whose behavior is watched. Then, the behavior of the watching target person is presumed based on the specified communication statuses of the plurality of wireless communication tags. Note that the “watching target person” is defined as a target person whose behavior is watched by the watching system and is exemplified by the inpatient, the care facility tenant and the care receiver.

Herein, the communication status of the wireless communication tag indicates whether the information transmitted from the wireless communication tag attached to the watching target person can be received or not. It is determined, basically from a distance between the wireless communication tag attached to the watching target person and the receiving apparatus and from an intensity of radio waves, whether or not the information transmitted from the wireless communication tag attached to the watching target person can be received. Therefore, a positional relationship between attaching positions of the plurality of wireless communication tags, in other words, the attaching regions of the body of the watching target person and an installing place of the receiving apparatus can be grasped from the respective communication statuses of the plurality of wireless communication tags attached to the watching target person. Then, the receiving apparatus is installed in the position serving as the reference for presuming the behavior of the watching target person, and hence, if capable of grasping the positional relationship between the regions of the body of the watching target person and the installing place of the receiving apparatus, the state of the watching target person can be presumed.

Therefore, according to the configuration described above, the behavior of the watching target person can be presumed based on the statuses of the communications performed between the wireless communication tags and the receiving apparatus, and hence it is possible to provide the watching system that is hard to be affected by the physical restraints.

Further, in another mode of the watching system according to one aspect, the plurality of wireless communication tags may include a first wireless communication tag and a second wireless communication tag, and the first wireless communication tag may be set shorter in communicable distance than the second wireless communication tag.

According to the configuration described above, as the communicable distance between the first wireless communication tag and the second wireless communication tag gets more differentiated, an area with a different communication status between the first wireless communication tag and the second wireless communication tag becomes easier to occur. Herein, in the watching system according to one aspect, the behavior of the watching target person is presumed based on the communication statuses of the respective wireless communication tags. Therefore, the behavior of the watching target person can be presumed diversely by effectively utilizing the area described above.

Moreover, in still another mode of the watching system according to one aspect, the first wireless communication tag and the second wireless communication tag are capable of performing communications at the same distance, and the communicable distance of the first wireless communication tag may be set shorter than the communicable distance of the second wireless communication tag by sealing its metallic material to weaken an intensity of radio waves thereof.

According to the configuration described above, even when preparing the same type of wireless communication tags, the wireless communication tags having different communicable distances can be manufactured by a simple method. Therefore, it follows that the wireless communication tags, which are different in terms of, e.g., a telecommunications standard, an output of the radio waves, etc, may not be prepared. Hence, according to the configuration described above, a cost thereof can be reduced. Note that the metallic material may be sufficient if shortening the communicable distance of the wireless communication tag to be sealed and is exemplified by an aluminum foil.

Furthermore, in yet another mode of the watching system according to one aspect, the information transmitted respectively from the plurality of wireless communication tags may contain tag identifying information for identifying each of the plurality of wireless communication tags. Further, the information processing apparatus, on the occasion of determining whether or not the receiving apparatus can receive the information transmitted from the plurality of wireless communication tags, may identify each wireless communication tag by referring to the tag identifying information contained in the received information, may thus specify the communication status of each of the plurality of wireless communication tags, and may presume the behavior of the watching target person on the basis of the respective communication statuses of the plurality of identified wireless communication tags. According to the configuration described above, the plurality of wireless communication tags with the respective communication statuses being specified is identified, thereby enabling the behavior of the watching target person to be presumed diversely and accuracy of presuming the behavior to be enhanced.

Moreover, in yet another mode of the watching system according to one aspect, the information transmitted from the plurality of wireless communication tags may contain target person identifying information for identifying each individual watching target person attached with the wireless communication tags. Then, the information processing apparatus may specify the watching target person whose behavior is presumed in a way that identifies the watching target person from the target person identifying information transmitted from the plurality of wireless communication tags. According to the configuration described above, even when there exists a plurality of watching target persons whose behaviors are presumed, the watching target persons can be identified from the target person identifying information, whereby the behaviors of the watching target persons can be presumed without confusing the wireless communication tags attached to the individual watching target persons.

Further, in an additional mode of the watching system according to one aspect, the information processing apparatus, when the presumed behavior of the watching target person is a behavior indicating a symptom that the watching target person will encounter with an impending danger, may issue notification for informing a watcher of the symptom, who watches the watching target person. According to the configuration described above, it is feasible to inform the watcher of the symptom that the watching target person will encounter with the impending danger. Moreover, the watching target person can be also notified of the symptom of the impending danger. Note that the watcher is a person who watches the behavior of the watching target person and is exemplified by a nurse, staff and a caregiver. The notification for informing of the symptom that the watching target person will encounter with the impending danger may be issued in cooperation with equipment installed in a facility such as a nurse call system.

It is to be noted that another mode of the watching system according to one aspect may be an information processing apparatus realizing the respective configurations described above, may also be an information processing method, may further be a program, and may yet further be a non-transitory storage medium recording a program, which can be read by a computer, other apparatuses and machines. Herein, the recording medium readable by the computer etc is a medium that accumulates the information such as the program electrically, magnetically, mechanically or by chemical action.

For example, an information processing apparatus according to one aspect of the present invention includes: a communication status specifying unit to specify respective communication statuses of a plurality of wireless communication tags by determining whether or not a receiving apparatus installed in a position serving as a reference for presuming a behavior of a watching target person can receive information transmitted from the plurality of wireless communication tags attached to the watching target person whose behavior is watched; and a behavior presuming unit to presume the behavior of the watching target person attached with the plurality of wireless communication tags on the basis of the specified communication statuses of the plurality of wireless communication tags.

Moreover, for example, an information processing method according to one aspect of the present invention is a method by which a computer executes: specifying respective communication statuses of a plurality of wireless communication tags by determining whether or not a receiving apparatus installed in a position serving as a reference for presuming a behavior of a watching target person can receive information transmitted from the plurality of wireless communication tags attached to the watching target person whose behavior is watched; and presuming the behavior of the watching target person attached with the plurality of wireless communication tags on the basis of the specified communication statuses of the plurality of wireless communication tags.

Furthermore, e.g., a non-transitory recording medium according to one aspect of the present invention is a medium recording a program to make a computer execute: specifying respective communication statuses of a plurality of wireless communication tags by determining whether or not a receiving apparatus installed in a position serving as a reference for presuming a behavior of a watching target person can receive information transmitted from the plurality of wireless communication tags attached to the watching target person whose behavior is watched; and presuming the behavior of the watching target person attached with the plurality of wireless communication tags on the basis of the specified communication statuses of the plurality of wireless communication tags.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates one example of a situation to which the present invention is applied;

FIG. 2A illustrates a relationship between a communication status of a wireless communication tag and a behavior of a watching target person in an embodiment; FIG. 2B illustrates a relationship between a communication status of the wireless communication tag and a behavior of the watching target person in the embodiment; and FIG. 2C illustrates a relationship between a communication status of the wireless communication tag and a behavior of the watching target person in the embodiment;

FIG. 3 illustrates hardware configurations of respective apparatuses according to the embodiment;

FIG. 4 illustrates a functional configuration of an information processing apparatus according to the embodiment;

FIG. 5 illustrates a processing procedure of the information processing apparatus according to the embodiment;

FIG. 6 illustrates a reference for presuming the behavior in the information processing apparatus according to the embodiment; and

FIG. 7A illustrates a relationship between a communication status of the wireless communication tag and a behavior of the watching target person in another embodiment; FIG. 7B illustrates a relationship between a communication status of the wireless communication tag and a behavior of the watching target person in another embodiment; and FIG. 7C illustrates a relationship between a communication status of the wireless communication tag and a behavior of the watching target person in another embodiment.

### DESCRIPTION OF EMBODIMENT

An embodiment (which will hereinafter be also termed “the present embodiment”) according to one aspect of the present invention will hereinafter be described based on the drawings. However, the present embodiment, which will hereinafter be explained, is no more than an exemplification of the present invention in every point. As a matter of course, the invention can be improved and modified in a variety of forms without deviating from the scope of the present invention. Namely, on the occasion of carrying out the present invention, a specific configuration corresponding to the embodiment may properly be adopted.

Note that data occurring in the present embodiment are, though described in a natural language, specified more concretely by use of a quasi-language, commands, parameters, a machine language, etc, which are recognizable to a computer.

### §1 Example of Applied Situation

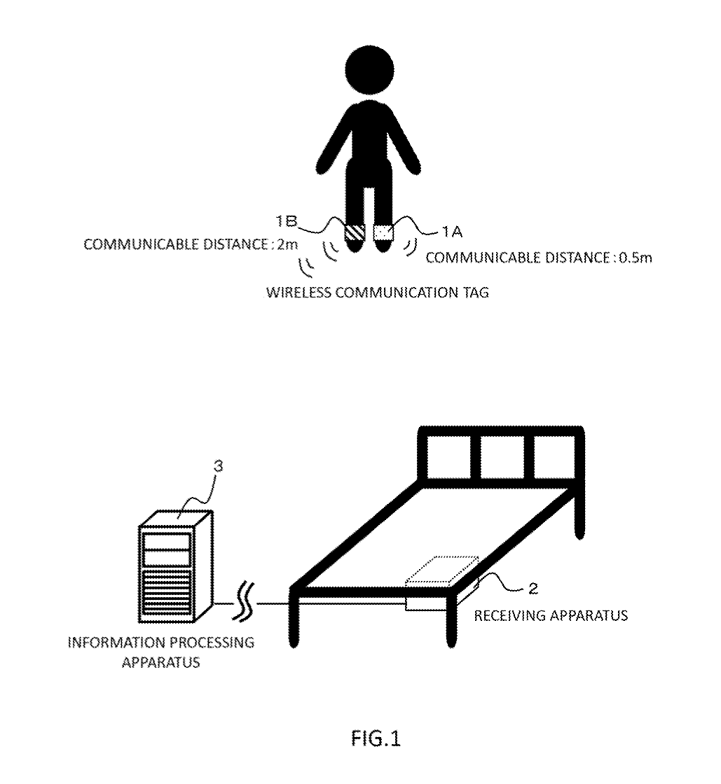

FIG. 1 illustrates one example of a situation to which the present invention is applied. The present embodiment assumes, as applied situations of the present invention, a situation of watching a behavior of an inpatient (a watching target person) in a medical treatment facility and a situation of watching a tenant (another watching target person) in a care facility. In the present embodiment, as depicted in FIG. 1, wireless communication tags (1A, 1B) are attached to portions vicinal to ankles of the watching target person. Note that if the wireless communication tags (1A, 1B) may not be distinguished from each other, the plurality of wireless communication tags are referred to as a “wireless communication tag 1” without making the distinction therebetween.

Herein, in the present embodiment, the wireless communication tag 1A is shorter in communicable distance than the wireless communication tag 1B. Namely, the wireless communication tag 1A corresponds to a first wireless communication tag according to the present invention, while the wireless communication tag 1B corresponds to a second wireless communication tag according to the present invention.

Note that the communicable distance of the wireless communication tag 1 may be properly set. For example, the wireless communication tags 1 each based on a different telecommunications standard or each having a different output of radio waves may also be employed as the wireless communication tags 1 each having a different communicable distance.

Further, e.g., the wireless communication tag 1A, though the same as the wireless communication tag 1B and enabled to perform the communications at the same distance as the wireless communication tag 1B is, may be set shorter in communicable distance than the wireless communication tag 1B because of the tag 1A being hindered from performing the wireless communications by sealing a metallic material thereof. The metallic material is a material such as an aluminum foil for narrowing the communicable distance of the wireless communication tag 1 to be sealed therewith. For instance, the aluminum foil is pasted to the surface of the wireless communication tag 1, whereby the communicable distance of the wireless communication tag 1 can be reduced. At this time, the communicable distance of the wireless communication tag 1 may be controlled by adjusting a coverage rate of covering the aluminum foil over the surface of the wireless communication tag 1.

The use of such a method enables, even when preparing the same type of wireless communication tags, a preparation of the plurality of wireless communication tags 1 each having the different communicable distance. It may therefore be unnecessary to prepare the wireless communication tags of which the telecommunications standards and the outputs of the radio waves are different from each other. Moreover, the communicable distance of the wireless communication tag 1 can be controlled, and hence the same type of wireless communication tags 1 can be applied to multiple situations, which may eliminate a necessity for preparing the different types of wireless communication tags 1 corresponding to presumed target behaviors of the watching target person. Accordingly, a cost can be reduced by using the method such as this.

It is to be noted that the present embodiment is contrived to set the respective wireless communication tags (1A, 1B) properly so that the wireless communication tag 1A is shorter in communicable distance than the wireless communication tag 1B.

A receiving apparatus 2 is installed in a position becoming a reference for presuming the behavior of the watching target person, and receives respective items of information transmitted from the wireless communication tags 1A and 1B. As will be described later on, in the present embodiment, the behavior of the watching target person is presumed corresponding to whether the information transmitted from the respective wireless communication tags 1 can be received or not. Namely, the behavior of the watching target person is presumed depending on a positional relationship between the wireless communication tags 1 and the receiving apparatus 2. Therefore, the position becoming the reference for presuming the behavior of the watching target person is determined based on the presumed target behavior of the watching target person, a posture of the watching target person when conducting this behavior, a position where the behavior is conducted, and so on.

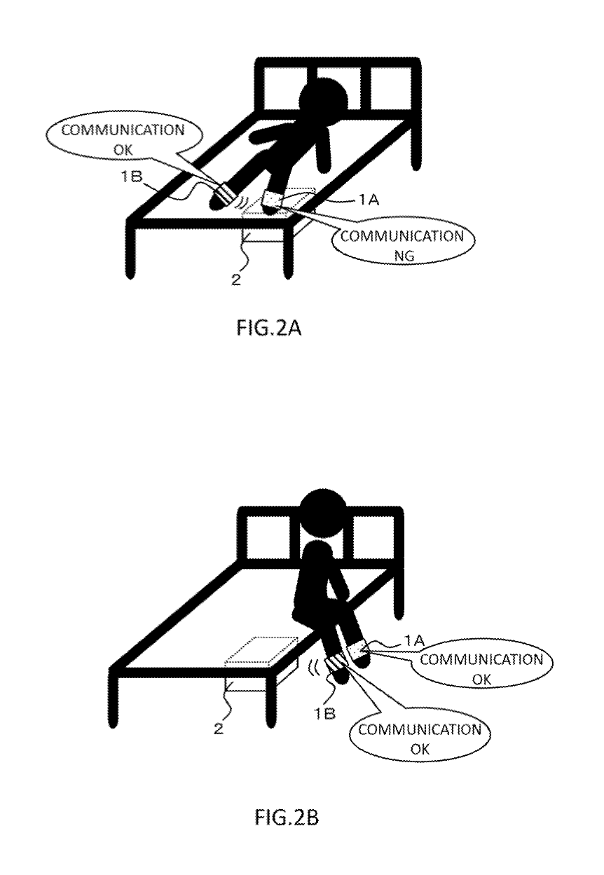

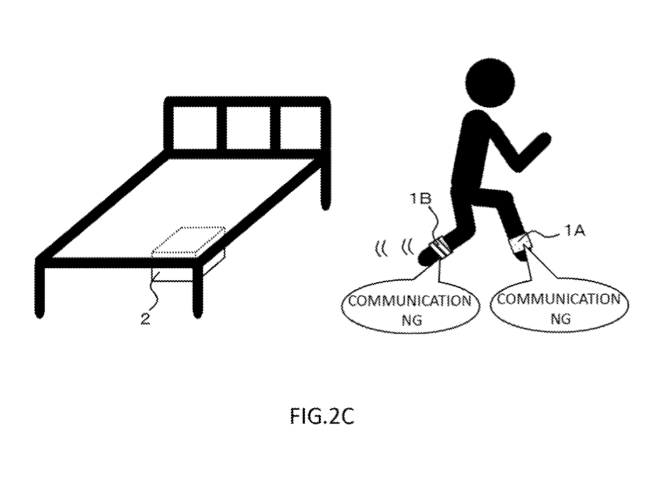

FIGS. 2A-2C each illustrate a relationship between a communication status of each of the plurality of wireless communication tags 1 and the behavior of the watching target person. The present embodiment exemplifies a residing-in-bed state (a state of the watching target person residing in a bed), a sitting-on-bed-edge state (a state of the watching target person sitting on an end of the bed) and a leaving-bed state (wandering) by way of one example of the presumed target behavior. To be specific, FIG. 2A illustrates a communication status of the wireless communication tags 1 when the watching target person resides in the bed (the residing-in-bed state). FIG. 2B depicts a communication status of the wireless communication tags 1 when the watching target person sits on an edge of the bed (the sitting-on-bed-edge state). FIG. 2C illustrates a status of the wireless communication tags 1 when the watching target person leaves the bed (wandering). Note that the “residing-in-bed state” indicates a state where the watching target person resides in the bed. Further, the “sitting-on-bed-edge state” indicates a state where the watching target person sits on the edge of the bed.

In the present embodiment, the behavior of the watching target person is presumed from a difference between the communication statuses of the wireless communication tags 1. The communicable distances of the wireless communication tags 1 and the position for installing the receiving apparatus 2 are properly set to differentiate the communication statuses of the wireless communication tags 1 between the plural presumed targeted behaviors of the watching target person. Note that a sequence of determining the communicable distances of the wireless communication tags 1 and the position for installing the receiving apparatus 2 is not particularly limited. The communicable distances of the wireless communication tags 1 may be set after determining the position for installing the receiving apparatus 2, and conversely the position for installing the receiving apparatus 2 may be determined after setting the communicable distances of the wireless communication tags 1.

For example, in the present embodiment, it is assumed that the watching target person takes postures illustrated in FIGS. 2A-2C when residing in the bed, sitting on the edge of the bed and leaving the bed (wandering). These behaviors can be presumed on the basis of the distances from the bed as depicted in FIGS. 2A-2C. Such being the case, at first, it may be determined that the receiving apparatus 2 is installed in the vicinity of the center of the underside of the bed.

Then, the communicable distances of the wireless communication tags (1A, 1B) may be set to differentiate the communication statuses of the wireless communication tags (1A, 1B) when residing in the bed, sitting on the edge of the bed and leaving the bed (wandering).

For instance, in the present embodiment, it is assumed that the watching target person, when leaving the bed, gets away farther from the vicinity of the bed installed with the receiving apparatus 2 than when residing in the bend and sitting on the edge of the bed. Hence, when leaving the bed, the communicable distances of the wireless communication tags (1A, 1B) are set so that both of the wireless communication tags (1A, 1B) get into a communication-disabled status.

On the other hand, there is no change in the situation that the watching target person exists on the bed between when residing in the bed and when sitting on the edge of the bed, however, a change occurs in positions vicinal to the ankles of the watching target person who is assumed to be attached with the wireless communication tags (1A, 1B). Specifically, it is assumed that the ankles of the watching target person become closer to the position vicinal to the center of the underside of the bed when sitting on the edge of the bed, which is defined as the position for installing the receiving apparatus 2, than when residing in the bed. This being the case, the communicable distances of the wireless communication tags (1A, 1B) are set so that both of the wireless communication tags (1A, 1B) get into the communication-enabled status when sitting on the edge of the bed. Then, the communicable distances of the wireless communication tags (1A, 1B) are set so that the wireless communication tag 1A gets into the communication-disabled status, while the wireless communication tag 1B gets into the communication-enabled status when residing in the bed.

Based on these assumptions according to the present embodiment, the communicable distances of the respective wireless communication tags (1A, 1B) may be set so that the wireless communication tag 1A is shorter in communicable distance than the wireless communication tag 1B. In this case, for example, the communicable distance of the wireless communication tag 1A is set to 0.5 m (meter), and the communicable distance of the wireless communication tag 1B is set to 2 m.

Further, for instance, after the communicable distances of the respective wireless communication tags (1A, 1B) have been set so that the wireless communication tag 1A is shorter in communicable distance than the wireless communication tag 1B, the position for installing the receiving apparatus 2 may be determined. In this case, supposing that the receiving apparatus 2 is installed so as to get into the communication statuses depicted in FIGS. 2A-2C, the receiving apparatus 2 is installed in a position where the wireless communication tag 1A is disabled from performing the communications, while the wireless communication tag 1B is enabled to perform the communication when residing in the bed and in a position where both of the wireless communication tags 1A and 1B are enabled to perform the communications when sitting on the edge of the bed. In the present embodiment, the receiving apparatus 2 may be installed in the vicinity of the center of the underside of the bed as one example of these positions.

Thus, the communicable distances of the wireless communication tags 1 and the installing position of the receiving apparatus 2 are properly set to differentiate the communication statuses of the wireless communication tags 1 between the plural patterns of presumed target behaviors of the watching target person. Hereupon, an information processing apparatus 3 according to the present embodiment determines whether or not the receiving apparatus 2 can receive the respective items of information transmitted from the plurality of wireless communication tags 1, thereby specifying the communication status of each of the plurality of wireless communication tags 1. Then, the information processing apparatus 3 presumes a state of the watching target person attached with the wireless communication tags in accordance with the specified communication statuses of the plurality of wireless communication tags.

In the present embodiment, to be specific, the wireless communication tag 1A is in the communication-disabled status with the receiving apparatus 2, while the wireless communication tag 1B is in the communication-enabled status with the receiving apparatus 2, in which case the information processing apparatus 3 presumes that the watching target person is in the residing-in-bed state. Further, the information processing apparatus 3, when both of the wireless communication tags 1A and 1B are in the communication-enabled status, presumes that the watching target person is in the sitting-on-bed-edge state. Then, the information processing apparatus 3, when both of the wireless communication tags 1A and 1B are in the communication-disabled status, presumes that the watching target person is in the leaving-bed state (wandering state).

Thus, the use of the wireless communication tags 1A and 1B each having the different communicable distance facilitates occurrence of distinguishable areas, in which one area covered by the wireless communication tag 1A is different in communication status from another area covered by the communication tag 1B. These areas can be allocated with the behaviors presumed with respect to the watching target person as exemplified by the residing-in-bed state (FIG. 2A) and the sitting-on-bed-edge state (FIG. 2B). The behavior of the watching target person can be therefore presumed more diversely as the watching target by using the wireless communication tags 1A and 1B having the different communicable distances.

Note that the information processing apparatus 3 and the receiving apparatus 2 may also be configured integrally as one apparatus. Further, the information processing apparatus 3 may be installed in any place if enabled to connect with the receiving apparatus 2 but may not be installed in the same room as the receiving apparatus 2 is installed.

### §2 Example of Configuration

<Example of Hardware Configuration>

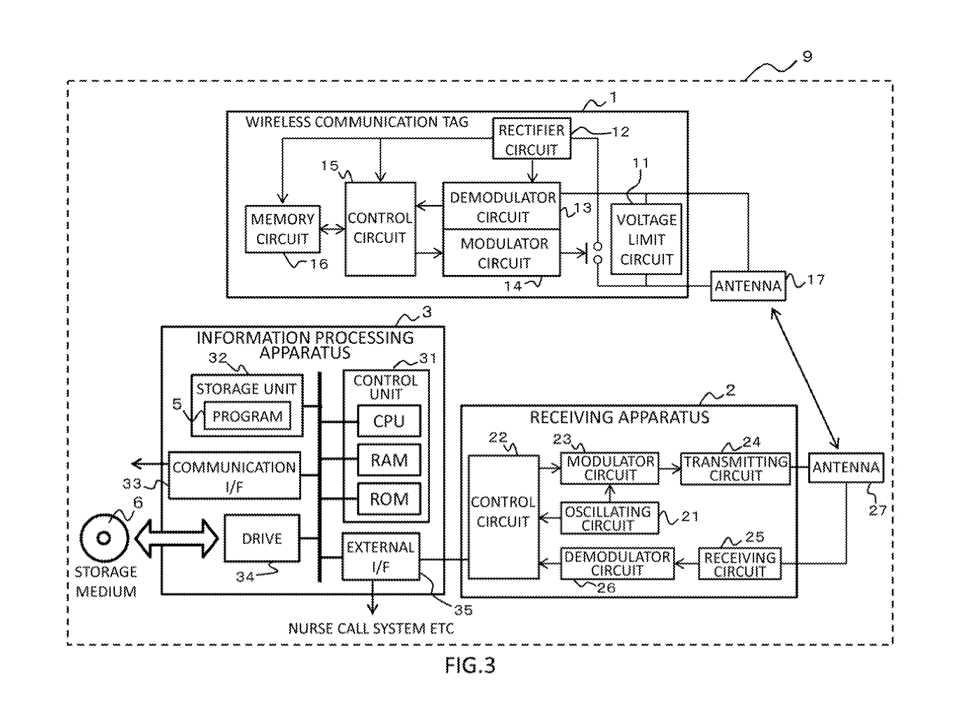

FIG. 3 illustrates hardware configurations of the wireless communication tags 1, the receiving apparatus 2 and the information processing apparatus 3 that are included in a watching system 9.

(Wireless Communication Tag)

The wireless communication tag 1 includes a voltage limit circuit 11, a rectifier circuit 12, a demodulator circuit 13, a modulator circuit 14, a control circuit 15, a memory circuit and an antenna 17. As for the specific hardware configuration of the wireless communication tag 1, the components thereof can be properly omitted, replaced and added corresponding to the embodiment.

The voltage limit circuit 11 is a circuit for protecting internal circuits from an excessive input to the antenna 17. The rectifier circuit 12 converts an alternating current inputted to the antenna 17 into a direct current, and supplies power to the internal circuits. The demodulator circuit 13 demodulates an AC signal inputted to the antenna 17, and transmits the demodulated signal to the control circuit 15. On the other hand, the modulator circuit 14 modulates the signal coming from the control circuit 15, and transmits information to the receiving apparatus 2 via the antenna 17.

The control circuit 15 is a circuit for controlling an operation of the wireless communication tag 1, and executes a variety of arithmetic processes corresponding to the inputted signals. The control circuit 15 may be built up by a logical circuit to a minimum requirement for the purpose of restraining power consumption and may also be built up by a large-scale circuit such as a CPU (Central Processing Unit).

The memory circuit 16 is a circuit for recording the information. As will be described later on, the present embodiment assumes an RF (Radio Frequency) tag as the wireless communication tag 1. Therefore, a memory area of the memory circuit 16 may include an area for storing a unique ID of the tag and accepting only reading. Incidentally, the memory circuit 16 can involve using, e.g., an EPROM (Electrically Programmable Read Only Memory), an EEPROM (Electrically Erasable and Programmable Read Only Memory), an FeRAM (Ferro electric Random Access Memory), an SRAM (Static Random Access Memory), etc.

It is to be noted that the information transmitted from the wireless communication tag 1 may contain tag identifying information for identifying the wireless communication tag 1 in the present embodiment. In this case, the tag identifying information is written to the memory circuit 16, and the control circuit 15 transmits the tag identifying information to the receiving apparatus 2 by properly controlling the modulator circuit 14. Herein, the tag identifying information may have any type of contents if being the conformation from which each wireless communication tag 1 can be identified. The tag identifying information is exemplified by a unique ID that is uniquely allocated to the wireless communication tag 1, information specifying a part attached with the wireless communication tag 1, and so on.

Further, in the present embodiment, the information transmitted from the wireless communication tag 1 may contain target person identifying information for identifying the watching target person attached with the wireless communication tag 1. In this case also, similarly to what is described above, the target identifying information is written to the memory circuit 16, and the control circuit 15 transmits the target identifying information to the receiving apparatus 2 by properly controlling the modulator circuit 14.

Incidentally, the present embodiment is based on a premise that the respective wireless communication tags 1 take the same configuration. If enabled to perform the communications with the receiving apparatus 2, however, at least some of the plural wireless communication tags 1 may take a different configuration.

Moreover, the present embodiment assumes that passive tags in RFID (Radio Frequency IDentification) tags are used as the wireless communication tags 1. The wireless communication tag 1 is available if being a device capable of transmitting the information through the wireless communications, however, tags other than the RF tags may also be employed. Furthermore, active tags (including power sources) may also be used as the wireless communication tags 1.

Moreover, the telecommunications standard of the wireless communication tag 1 may be properly determined corresponding to the embodiment. For example, Bluetooth (registered trademark), ZigBee (registered trademark), UWB (Ultra Wide Band), etc may be utilized as the telecommunications standard of the wireless communication tag 1. Note that in the present embodiment, the behavior of the watching target person is presumed corresponding to whether the communications between the respective wireless communication tags 1 and the receiving apparatus 2 can be performed or not. Consequently, the use of the telecommunications standard utilized for near field communications (NFC) covering the communications at a distance up to several tens of meters, facilitates the assumption of the relationship between the communication status and the behavior of the watching target person and is therefore preferable. However, as described above, the communicable distance can be shortened by sealing the metallic material and thus hindering the wireless communications. Therefore, the telecommunications standards other than the telecommunications standard of the near field communications such as this can be utilized in the present embodiment. In the case of employing the watching system 9 according to the present embodiment in medical treatment sites, however, it is preferable to utilize the telecommunications standards not affecting medical devices such as heart pacemakers.

Further, the two pieces of wireless communication tags 1 are used in the present embodiment. However, the number of the wireless communication tags 1 attached to the watching target person is not limited to “2”, and three or more wireless communication tags may also be attached to the watching target person. The number of the wireless communication tags 1 may be properly determined corresponding to the embodiment.

Moreover, the part attached with the wireless communication tag 1 is not confined to the vicinity of the ankle but may be properly determined corresponding to the embodiment. Note that the wireless communication tags 1 are, it is preferable, attached to such portions, e.g., trouser cuffs, a trouser waist, a collar and wristbands of an outer wear, etc that the watching target person gets hard to be aware of the wireless communication tags 1 being attached thereto. Further, the communication status of the wireless communication tag 1 can be changed corresponding to the distance between the wireless communication tag 1 and the receiving apparatus 2. It is therefore preferable that the wireless communication tags 1 are attached to such portions that the change in distance from the receiving apparatus 2 is easy to occur between the plural behaviors as the presumed targets.

Moreover, the wireless communication tags 1 are basically always attached to the watching target person. Hence, it is preferable that the wireless communication tag 1 is small in size and in weight to such an extent as not to restrict the activities of the watching target person. The wireless communication tag 1, which is small in size and in weight, is easy to be attached to the watching target person and makes it difficult for the watching target person to be aware of the wireless communication tag 1 being attached thereto.

(Receiving Apparatus)

The receiving apparatus 2 includes an oscillating circuit 21, a control circuit 22, a modulator circuit 23, a transmitting circuit 24, a receiving circuit 25, a demodulator circuit 26 and an antenna 27. As for the specific hardware configuration of the receiving apparatus 2, the components thereof can be properly omitted, replaced and added corresponding to the embodiment.

The oscillating circuit 21 generates carrier waves used for the communications with the wireless communication tag 1. The control circuit 22 performs controlling from the side of the receiving apparatus 2 such as controlling the communications with the information processing apparatus 3 and controlling the communications with the wireless communication tag 1.

The modulator circuit 23 modulates the signals coming from the control circuit 22 by superimposing the signals onto the carrier waves generated in the oscillating circuit 21, and transmits the modulated signals to the transmitting circuit 24. Then, the transmitting circuit 24 transmits the signals superimposed onto the carrier waves sent from the modulator circuit 23 to the wireless communication tag 1 via the antenna 27. On the other hand, the receiving circuit 25 receives the carrier waves transmitted from the wireless communication tag 1 and entering via the antenna 27. Then, the demodulator circuit 26 demodulates the signals superimposed onto the carrier waves received by the receiving circuit 25, and transmits the demodulated signals to the control circuit 22.

Note that the present embodiment assumes utilizing a reader/writer in the RFID as the receiving apparatus 2. The receiving apparatus 2 may also, however, be an apparatus other than the reader/writer if capable of receiving the information wirelessly transmitted from the wireless communication tag 1.

(Information Processing Apparatus 3)

The information processing apparatus 3 is a computer including: a control unit 31 containing a CPU, a RAM (Random Access Memory) and a ROM (Read Only Memory); a storage unit 32 storing a program 5 etc executed by the control unit 31; a communication interface 33 for performing the communications via the network; a drive 34 for reading the program stored on a storage medium 6; and an external interface 35 for establishing a connection with an external device, which are all electrically connected to each other. As for the specific hardware configuration of the information processing apparatus 3, the components thereof can be properly omitted, replaced and added corresponding to the embodiment. For instance, the control unit 31 may include a plurality of processors. Furthermore, the information processing apparatus 3 may be equipped with output devices such as a display and input devices for inputting such as a mouse and a keyboard. Note that the communication interface and the external interface are abbreviated to the “communication I/F” and the “external I/F” respectively in FIG. 3.

It is to be noted that the information processing apparatus 3 may include a plurality of external interfaces 35 and may be connected to the external devices through these interfaces 35. In the present embodiment, the information processing apparatus 3 is connected via the external interface 35 to the receiving apparatus 2 so that the apparatus 3 can control the receiving apparatus 2. Further, in the present embodiment, notification for informing of a symptom that the watching target person will encounter with an impending danger, may be issued in cooperation with equipment such as a nurse call system installed in a facility. In this case, the information processing apparatus 3 may be connected via the external I/F 35 to the equipment with which the apparatus 3 cooperates to issue the notification.

Further, a program 5 is a program for making the information processing apparatus 3 execute steps contained in the operation that will be explained later on, and corresponds to a “program” according to the present invention. Moreover, the program 5 may be recorded on the storage medium 6. The storage medium 6 is a non-transitory medium that accumulates information such as the program electrically, magnetically, optically, mechanically or by chemical action so that the computer, other apparatus and machines, etc can read the information such as the recorded program. The storage medium 6 corresponds to a “non-transitory storage medium” according to the present invention. Note that FIG. 3 illustrates a disk type storage medium such as a CD (Compact Disk) and a DVD (Digital Versatile Disk) by way of one example of the storage medium 6. It does not, however, mean that the type of the storage medium 6 is limited to the disk type, and other types excluding the disk type may be available. The storage medium other than the disk type can be exemplified by a semiconductor memory such as a flash memory.

Note that the information processing apparatus 3 may involve using, in addition to, e.g., an apparatus designed for an exclusive use for a service to be provided, general-purpose apparatuses such as a PC (Personal Computer) and a tablet terminal. Further, the information processing apparatus 3 may be implemented by one or a plurality of computers.

### <Example of Functional Configuration>

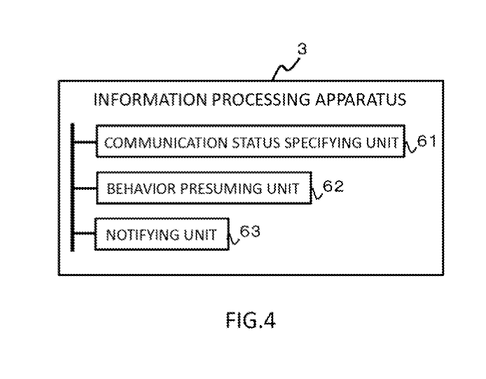

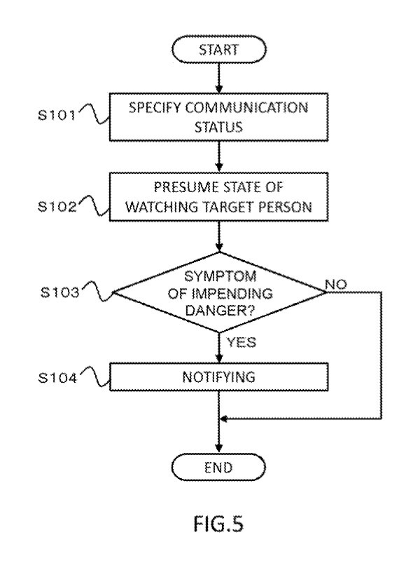

FIG. 4 illustrates a functional configuration of the information processing apparatus 3 according to the present embodiment. The CPU provided in the information processing apparatus 3 according to the present embodiment deploys the program 5 on the RAM, which is stored in the storage unit 32. Then, the CPU interprets and executes the program 5 deployed on the RAM, thereby controlling the respective components. Through this operation, the information processing apparatus 3 according to the present embodiment functions as the computer including a communication status specifying unit 61, a behavior presuming unit 62 and a notifying unit 63. Note that the present embodiment discusses an example in which each of these functions is realized by the general-purpose CPU. Some or the whole of these functions may, however, be realized by one or a plurality of dedicated processors.

The communication status specifying unit 61 determines whether or not the receiving apparatus 2 can receive the information transmitted from the plurality of wireless communication tags 1, thereby specifying the respective communication statuses of the plurality of wireless communication tags 1. The behavior presuming unit 62 presumes the behavior of the watching target person attached with the plurality of wireless communication tags 1 on the basis of the specified communication statuses of the plurality of wireless communication tags 1.

Note that the information transmitted from the wireless communication tag 1 may contain the tag identifying information for identifying the wireless communication tag 1 in the present embodiment. In this case, the communication status specifying unit 61 may, on the occasion of determining whether the receiving apparatus 2 can receive the information transmitted from the plurality of wireless communication tags 1 or not, identify each wireless communication tag 1 by referring to the tag identifying information. Then, the behavior presuming unit 62 may presume the behavior of the watching target person on the basis of the respective communication statuses of the plurality of identified wireless communication tags 1.

Moreover, in the present embodiment, the information transmitted from the wireless communication tags 1 may contain target person identifying information for identifying the watching target person attached with the wireless communication tags 1. In this case, the behavior presuming unit 62 may specify the watching target person with his or her behavior being presumed in a way that identifies the watching target person from the target person identifying information.

Further, in the present embodiment, the information processing apparatus 3 may issue the notification for informing of the symptom that the watching target person will encounter with the impending danger. In this case, the notifying unit 63 may, when the behavior presumed by the behavior presuming unit 62 with respect to the watching target person is a behavior indicating the symptom that the watching target person will encounter with the impending danger, issue the notification for informing a watcher of this symptom, who watches the watching target person.

### §3 Operational Example

FIG. 5 illustrates an operational example of the information processing apparatus 3 according to the present embodiment. It is to be noted that a processing procedure of the operational example given in the following discussion is nothing but one example, and the respective processes may be replaced to the greatest possible degree as far as there is no subordination such as using results of processes executed before these former processes. Further, as for the processing procedure of the operational example given in the following discussion, the processes thereof can be properly omitted, replaced and added corresponding to the embodiment. For instance, in the watching system 9, if not issuing the notification for informing of the symptom that the watching target person will encounter with the impending danger, steps S103 and S104 may be omitted.

In step S101, the control unit 31 functions as the communication status specifying unit 61 and determines whether or not the receiving apparatus 2 can receive the respective items of information transmitted from the plurality of wireless communication tags 1, thereby specifying the respective communication statuses of the plurality of wireless communication tags 1.

In the present embodiment, the control unit 31 determines whether or not the receiving apparatus 2 connected via the external I/F 35 can receive the information transmitted respectively from the wireless communication tags 1A and 1B. Note that the contents of the information transmitted respectively from the wireless communication tags 1A and 1B may be properly determined corresponding to the embodiment.

In the present embodiment, the communicable distances of the respective wireless communication tags (1A, 1B) are set so that the wireless communication tag 1A is shorter in communicable distance than the wireless communication tag 1B. Hence, in the case depicted in FIG. 2A, it is assumed that the receiving apparatus 2 cannot receive the information transmitted from the wireless communication tag 1A but can receive the information transmitted from the wireless communication tag 1B. Accordingly, in the case depicted in FIG. 2A, the control unit 31 specifies the communication statuses of the wireless communication tags (1A, 1B) in step S101 such that the wireless communication tag 1A is in the communication-disabled status with the receiving apparatus 2 and that the wireless communication tag 1B is in the communication-enabled status with the receiving apparatus 2.

Moreover, in the case depicted in FIG. 2B, it is assumed that the receiving apparatus 2 can receive the information transmitted respectively from the wireless communication tags (1A, 1B). Therefore, in the case depicted in FIG. 2B, the control unit 31 specifies the communication statuses of the wireless communication tags (1A, 1B) in step S101 such that both of wireless communication tags (1A, 1B) are in the communication-enabled status with the receiving apparatus 2.

Similarly, in the case depicted in FIG. 2C, it is assumed that the receiving apparatus 2 cannot receive the information transmitted respectively from the wireless communication tags (1A, 1B). Hence, in the case depicted in FIG. 2C, the control unit 31 specifies the communication statuses of the wireless communication tags (1A, 1B) in step S101 such that both of wireless communication tags (1A, 1B) are in the communication-disabled status with the receiving apparatus 2.

In step S102, the control unit 31 functions as the behavior presuming unit 62 and presumes the behavior of the watching target person attached with the plurality of wireless communication tags 1 on the basis of the communication statuses specified with respect to the plurality of wireless communication tags 1.

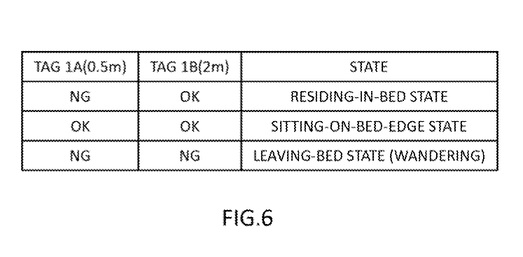

FIG. 6 illustrates the judgment conditions for presuming the behavior of the watching target person in the present embodiment. In the present embodiment, the information processing apparatus 3 presumes the behavior of the watching target person on the assumption of the situations as depicted in FIGS. 2A-2C.

(a) Residing-in-Bed State (FIG. 2A)

In the present embodiment, the communicable distances of the respective wireless communication tags (1A, 1B) are set so that the wireless communication tag 1A is shorter in communicable distance than the wireless communication tag 1B. Then, when in the posture of the watching target person as illustrated in FIG. 2A, the communicable distances of the wireless communication tags (1A, 1B) and the installing position of the receiving apparatus 2 are determined so that the wireless communication tag 1A is in the communication-disabled status with the receiving apparatus 2 and that the wireless communication tag 1B is in the communication-enabled status with the receiving apparatus 2. Moreover, when the watching target person takes the posture as depicted in FIG. 2A, the receiving apparatus 2 is installed in such a position that the tag 1A is disabled from performing the communications, while the tag 1B is enabled to perform the communications.

Therefore, in the case of the situation as depicted in FIG. 2A, the control unit 31 specifies the respective communication statuses in step S101 such that the wireless communication tag 1A is in the communication-disabled status with the receiving apparatus 2 and that the wireless communication tag 1B is in the communication-enabled status with the receiving apparatus 2. In this case, the control unit 31 presumes the behavior of the watching target person in step S102 such that the watching target person exists on the bed (the residing-in-bed state) on the basis of the specified communication statuses of the wireless communication tags 1A and 1B.

(b) Sitting-on-Bed-Edge State (FIG. 2B)

In the present embodiment, as depicted in FIG. 2B, when in the sitting-on-bed-edge state where a part vicinal to the ankle of the watching target person attached with the wireless communication tag 1A gets closer to the receiving apparatus 2 than when in the residing-in-bed state, the wireless communication tag 1A comes to the communication-enabled status with the receiving apparatus 2. Therefore, the control unit 31 specifies the respective communication statuses in step S101 such that both of the wireless communication tags 1A and 1B are in the communication-enabled status with the receiving apparatus 2. In this instance, the control unit 31 presumes the behavior of the watching target person in step S102 such that the watching target person sits on the edge of the bed (the sitting-on-bed-edge state) on the basis of the specified communication statuses of the wireless communication tags 1A and 1B as described above.

(c) Leaving-Bed State (Wandering) (FIG. 2C)

In the present embodiment, as depicted in FIG. 2C, when in the leaving-bed state (wandering), the watching target person leaves the bed installed with the receiving apparatus 2, and hence both of the wireless communication tags (1A, 1B) come to the communication-disabled status with the receiving apparatus 2. Therefore, in the case of the situation as illustrated in FIG. 2C, the control unit 31 specifies the respective communication statuses in step S101 such that both of the wireless communication tags 1A and 1B are in the communication-disabled status with the receiving apparatus 2. In this case, the control unit 31 presumes the behavior of the watching target person in step S102 such that the watching target person leaves the bed (wandering) on the basis of the specified communication statuses of the wireless communication tags 1A and 1B.

In step S103, the control unit 31 determines whether or not the behavior presumed in step S102 is a behavior indicating the symptom that the watching target person will encounter with the impending danger. If the behavior presumed in step S102 is the behavior indicating the symptom that the watching target person will encounter with the impending danger, the control unit 31 advances the processing to step S104. Whereas if the behavior presumed in step S102 is not the behavior indicating the symptom that the watching target person will encounter with the impending danger, the control unit 31 finishes the processes related to the present operational example.

The behavior set for indicating the symptom that the watching target person will encounter with the impending danger, may be properly determined corresponding to the embodiment. An assumption is that, for example, the state of sitting on the edge of the bed, which implies a possibility that the watching target person will come down or fall down, is set as the behavior indicating the symptom that the watching target person will encounter with the impending danger. In this case, the control unit 31, when presuming in step S102 that the watching target person is in the sitting-on-bed-edge state, determines that the behavior presumed in step S102 is the behavior indicating the symptom that the watching target person will encounter with the impending danger.

Incidentally, on the occasion of determining whether or not there exists the symptom that the watching target person will encounter with the impending danger, it is better to take account of transitions of the behaviors of the watching target person as the case may be. For example, it can be assumed that a transition from the residing-in-bed state to the sitting-on-bed-edge state has a higher possibility that the watching target person will come down or fall down than a transition from the leaving-bed state to the sitting-on-bed-edge state. Such being the case, the control unit 31 may determine by taking account of the transitions of the behaviors of the watching target person whether or not the behavior presumed in step S102 is the behavior indicating the symptom that the watching target person will encounter with the impending danger. For instance, when the behavior, presumed in step S102, of the watching target person transitions from the residing-in-bed state to the sitting-on-bed-edge state while periodically presuming the behavior of the watching target person, the control unit 31 may determine in step S103 that the behavior presumed in step S102 is the behavior indicating the symptom that the watching target person will encounter with the impending danger.

In step S104, the control unit 31 functions as the notifying unit 63 and issues the notification, to the watcher who watches the watching target person, for informing of the symptom that the watching target person will encounter with the impending danger.

The control unit 31 issues the notification by using an appropriate method. By way of the notification, the control unit 31 may instruct, e.g., a display device connected to the information processing apparatus 3 to display a window for informing the watcher of the symptom that the watching target person will encounter with the impending danger. Furthermore, the control unit 31 may notify a user terminal of the watcher by e-mail. In this case, an e-mail address of the user terminal as a receiver of the notification is previously registered in the storage unit 32, and the control unit 31 gives the watcher the notification for informing of the symptom that the watching target person will encounter with the impending danger by use of the pre-registered e-mail address.

Moreover, the notification for informing of the symptom that the watching target person will encounter with the impending danger, may be issued in cooperation with the equipment such as the nurse call system installed in the facility. For instance, by way of the notification for informing of the symptom that the watching target person will encounter with the impending danger, the control unit 31 may control the nurse call system connected via the external I/F 35 and may perform calling through this nurse call system. The facility equipment connected to the information processing apparatus 3 may be properly determined corresponding to the embodiment.

Note that the information processing apparatus 3 periodically repeats the processes given in the operational example described above in the case of periodically presuming the behavior of the watching target person. An interval of periodically repeating the processes may be properly set. Further, the information processing apparatus 3 may also execute the processes given in the operational example in response to a request of the user (watcher).

The watching system 9 according to the present embodiment presumes the behavior of the watching target person on the basis of the communication statuses between the plurality of wireless communication tags 1 attached to the watching target person and the receiving apparatus 2. Consequently, the wireless communication tags can be much harder to be affected by physical restraints than a load sensor and a body motion type wire. The use of the sufficiently small-sized and light-weight wireless communication tags 1 enables the presumption of the behavior of the watching target person without restricting the behavior of the watching target person and making the watching target person be aware of his or her behavior being presumed by the system.

Moreover, the watching system 9 according to the present embodiment presumes the behavior of the watching target person not by analyzing details of the behavior of the watching target person as by a motion capture using an optical sensor etc but by associating the communication status of the wireless communication tags 1 with the behavior of the watching target person. Therefore, the watching system 9 according to the present embodiment presumes the behavior of the watching target person by a simpler method than the method using the motion capture. Hence, the watching system 9 can conduct the setting for adapting the system to the individual environment of the watching target person and can execute working, operating and manipulating easier than by the system using the motion capture.

### §4 Modified Example

The in-depth description of the embodiment of the present invention has been made, however, the description given so far is no more than the exemplification of the present invention in every point. As a matter of course, the invention can be improved and modified in the variety of forms without deviating from the scope of the present invention.

(Utilization of Tag Identifying Information)

For example, the information transmitted respectively from the plurality of wireless communication tags 1 may contain the tag identifying information described above. In this case, in step S101 described above, the control unit 31 specifies which tag of the plurality of wireless communication tags 1 the received information is transmitted from by referring to the tag identifying information contained in the received information, and identifies the wireless communication tag 1 as a sender tag of the received information. The wireless communication tag 1 kept in the communication-disabled status can be specified by identifying the sender tag of the received information, in other words, identifying the wireless communication tag 1 kept in the communication-enabled status. Therefore, the control unit 31 can specify the respective communication statuses while identifying respectively the plurality of wireless communication tags 1 by identifying the sender tag of the received information.

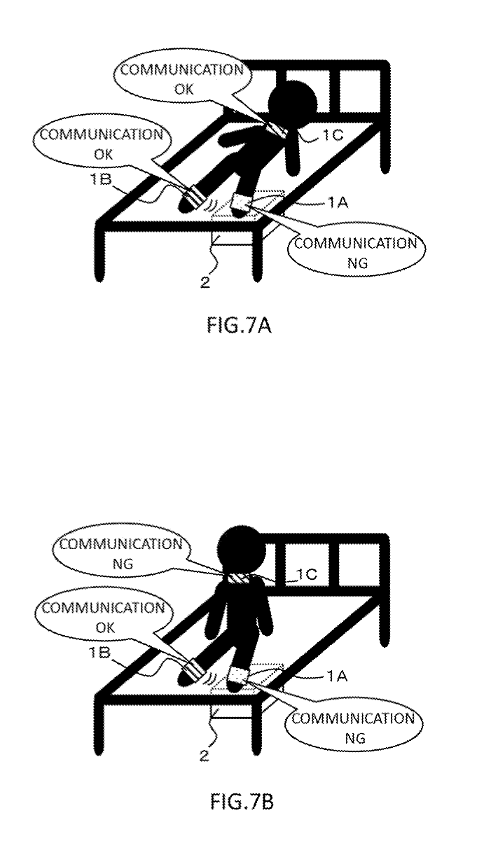

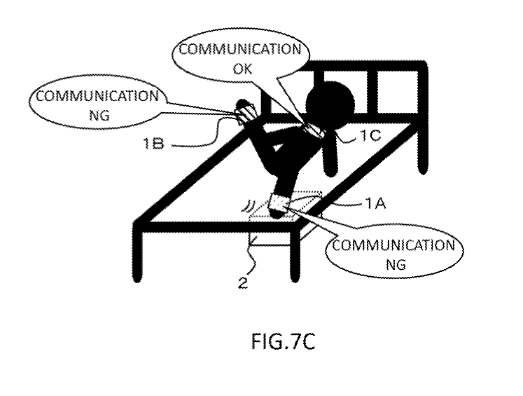

Then, in step S102 described above, the control unit presumes the behavior of the watching target person on the basis of the respective communication statuses of the plurality of identified wireless communication tags 1, thereby enabling the behavior of the watching target person to be presumed diversely and enhancing accuracy to presume the behavior. Discussion on this point will be made with reference to FIGS. 7A-7C.

FIGS. 7A-7C illustrate situations using three pieces of wireless communication tags (1A, 1B, 1C). Specifically, FIG. 7A depicts the communication statuses of the wireless communication tags (1A, 1B, 1C) with the receiving apparatus 2 when the watching target person sleeps on the bed. FIG. 7B depicts the communication statuses of the wireless communication tags (1A, 1B, 1C) with the receiving apparatus 2 when the watching target person gets up from the bed. FIG. 7C depicts the communication statuses of the wireless communication tags (1A, 1B, 1C) with the receiving apparatus 2 when the watching target person lifts up the leg attached with the wireless communication tag 1B.

Herein, the wireless communication tag 1C is attached to the neck (collar), and it is assumed that the communicable distance thereof is the same as that of the wireless communication tag 1B. Then, it is also assumed that the behavior of the watching target person, which is presumed by the watching system 9 (the information processing apparatus 3), includes a state in which the watching target person gets up from the bed as illustrated in FIG. 7B.

At this time, supposing that the information processing apparatus 3 does not identify the wireless communication tags 1, such a possibility exists that the control unit 31 specifies the state depicted in FIG. 7B and the state depicted in FIG. 7C as the same communication status. Namely, the possibility is that in both of these states, the control unit 31 specifies the communication statuses of the wireless communication tags 1 such that one wireless communication tag 1 is in the communication-enabled status with the receiving apparatus 2, while the other wireless communication tag 1 is in the communication-disabled status with the receiving apparatus 2. Therefore, the control unit 31 has a possibility of being unable to presume the behavior of the watching target person by distinguishing between the state depicted in FIG. 7B and the state depicted in FIG. 7C.

While on the other hand, supposing that the information processing apparatus 3 identifies the wireless communication tags 1, the control unit 31 can specify the state depicted in FIG. 7B and the state depicted in FIG. 7C as the different communication statuses. Specifically, the control unit 31 can distinguish between the communication statuses in the respective states such that the wireless communication tag 1B is in the communication-enabled status with the receiving apparatus 2 in the state illustrated in FIG. 7B, and the wireless communication tag 1C is in the communication-enabled status with the receiving apparatus 2 in the state illustrated in FIG. 7C. Thereupon, the control unit 31 can presume that the watching target person gets up from the bed when the wireless communication tags 1A and 1C are in the communication-disabled status with the receiving apparatus 2 and when the wireless communication tag 1B is in the communication-enabled status with the receiving apparatus 2. The behavior of the watching target person can be thus presumed by distinguishing between the state depicted in FIG. 7B and the state depicted in FIG. 7C.

Accordingly, the control unit 31 identifies the plurality of wireless communication tags 1 and presumes the behavior of the watching target person on the basis of the respective communication statuses of the plurality of identified wireless communication tags 1, thereby enabling the behavior of the watching target person to be presumed diversely and the behavior presuming accuracy to be enhanced.

(Utilization of Identifying Information of Target Person)

Further, for instance, the information transmitted respectively from the plurality of wireless communication tags 1 may contain the identifying information of the watching target person. In this case, in step S101 described above, the control unit 31 refers to the watching target person identifying information contained in the received information, thereby specifying what watching target person is attached with the wireless communication tag 1 from which the received information is transmitted. Then, the control unit 31 identifies the watching target person attached with the wireless communication tag 1 defined as the sender tag of the received information. Through this identifying process, the control unit 31 may specify the respective communication statuses of the plurality of wireless communication tags 1 per plurality of watching target persons in the case of setting the plurality of watching target persons as the behavior presuming targets based on the present process.

Then, in step S102 described above, the control unit 31 presumes the behavior of every watching target person on the basis of the communication status about every watching target person specified in step S101. Through this process, the information processing apparatus 3 can presume the behavior of every watching target person, even when there exists the plurality of watching target persons with their behaviors being presumed, without confusing the wireless communication tags 1 attached to the individual watching target persons.

According to one aspect, the present embodiment aims at providing the watching system that is hard to be affected by the physical restraints. Then, as discussed above, according to the present embodiment, it is feasible to provide the watching system that is hard to be affected by the physical restraints.

1. A watching system comprising:
a plurality of wireless communication tags to be attached to a watching target person whose behavior is watched;
a receiving apparatus to be installed in a position serving as a reference for presuming the behavior of the watching target person and to receive information transmitted respectively from the plurality of wireless communication tags; and
an information processing apparatus to specify respective communication statuses of the plurality of wireless communication tags by determining whether or not the receiving apparatus can receive the information transmitted from the plurality of wireless communication tags and to presume the behavior of the watching target person attached with the plurality of wireless communication tags on the basis of the specified communication statuses of the plurality of wireless communication tags.

2. The watching system according to claim 1, wherein the plurality of wireless communication tags includes a first wireless communication tag and a second wireless communication tag, and
the first wireless communication tag is shorter in communicable distance than the second wireless communication tag.
The watching system according to claim 2, wherein the first wireless communication tag and the second wireless communication tag are capable of performing communications at the same distance, and
the communicable distance of the first wireless communication tag is set shorter than the communicable distance of the second wireless communication tag by sealing its metallic material to weaken an intensity of radio waves thereof.

3. The watching system according to claim 1, wherein the information transmitted respectively from the plurality of wireless communication tags contains tag identifying information for identifying each of the plurality of wireless communication tags, and
the information processing apparatus, on the occasion of determining whether or not the receiving apparatus can receive the information transmitted from the plurality of wireless communication tags, identifies each wireless communication tag by referring to the tag identifying information contained in the received information, thus specifies the communication status of each of the plurality of wireless communication tags, and presumes the behavior of the watching target person on the basis of the respective communication statuses of the plurality of identified wireless communication tags.

4. The watching system according to claim 1, wherein the information transmitted from the plurality of wireless communication tags contains target person identifying information for identifying each individual watching target person attached with the wireless communication tags, and
the information processing apparatus specifies the watching target person whose behavior is presumed in a way that identifies the watching target person from the target person identifying information transmitted from the plurality of wireless communication tags.

5. The watching system according to claim 1, wherein the information processing apparatus, when the presumed behavior of the watching target person is a behavior indicating a symptom that the watching target person will encounter with an impending danger, issues notification for informing a watcher of the symptom, who watches the watching target person.

6. An information processing method by which a computer executes:
specifying respective communication statuses of a plurality of wireless communication tags by determining whether or not a receiving apparatus installed in a position serving as a reference for presuming a behavior of a watching target person can receive information transmitted from the plurality of wireless communication tags attached to the watching target person whose behavior is watched; and
presuming the behavior of the watching target person attached with the plurality of wireless communication tags on the basis of the specified communication statuses of the plurality of wireless communication tags.

7. A non-transitory recording medium recording a program to make a computer execute:
specifying respective communication statuses of a plurality of wireless communication tags by determining whether or not a receiving apparatus installed in a position serving as a reference for presuming a behavior of a watching target person can receive information transmitted from the plurality of wireless communication tags attached to the watching target person whose behavior is watched; and
presuming the behavior of the watching target person attached with the plurality of wireless communication tags on the basis of the specified communication statuses of the plurality of wireless communication tags.
